(19) United States
(12) Patent Application Publication
(10) Pub. No.: US 2025/0139868 A1
(43) Pub. Date: May 1, 2025

(54) APPARATUS AND METHOD FOR PROCESSING IMAGE

(71) Applicant: Electronics and Telecommunications Research Institute, Daejeon (KR)

(72) Inventors: Sang Yun KIM, Daejeon (KR); Mun Seob LEE, Daejeon (KR); Chihoon KIM, Daejeon (KR)

(73) Assignee: Electronics and Telecommunications Research Institute, Daejeon (KR)

(21) Appl. No.: 18/921,217

(22) Filed: Oct. 21, 2024

(30) Foreign Application Priority Data
Oct. 31, 2023 (KR) 10-2023-0148384
Sep. 4, 2024 (KR) 10-2024-0119987

(51) Int. Cl. G06T 15/00; G06T 7/62

(52) U.S. Cl. CPC G06T 15/00; G06T 7/62

(57) ABSTRACT

A method for image processing is provided. The method includes a step of collecting training data including a raw image, a two-dimensional (2D) image, and a depth image of the same object by using a data collection device, a step of learning the raw image and the 2D image to directly reconstruct a three-dimensional (3D) image from the raw image by using a diffusion network executed by a processor, based on a deep denoising learning method, and a step of updating a parameter of the diffusion network by using an update unit executed by the processor, based on a loss function representing a difference between the reconstructed 3D image and the depth image.

### CROSS-REFERENCE TO RELATED APPLICATIONS

This application claims the benefit of the Korean Patent Application Nos. 10-2023-0148384 filed on Oct. 31, 2023, and 10-2024-0119987 filed on Sep. 4, 2024, which are hereby incorporated by reference as if fully set forth herein.

### BACKGROUND

### Field of the Invention

The present disclosure relates to an apparatus and method for image processing, and more particularly, to an apparatus and method for plenoptic image processing for obtaining a high-resolution three-dimensional (3D) image.

### Discussion of the Related Art

Plenoptic image processing is technology for generating or reconstructing a three-dimensional (3D) image by using spatial information and angular information obtained by a plenoptic camera as well known.

In detail, plenoptic image processing converts a microlens image, corresponding to a raw image obtained by a plenoptic camera, into a plurality of sub-aperture images having a multi-viewpoint, analyzes a correlation between the sub-aperture images to obtain depth information, and generates or reconstructs a 3D image, based on the obtained depth information. Here, a size of each of the sub-aperture images is the spatial information, and the total number of sub-aperture images is the angular information.

Moreover, a plenoptic camera uses a microlens lens array so as to simultaneously capture several-direction light information in a single sensor. Each microlens records specific-direction light, and thus, a total resolution of a sensor is divided into a plurality of sub-aperture images. As a result, a resolution of an individual sub-aperture image is lower than an original resolution of the plenoptic camera. Due to such resolution division, a problem where a resolution of a finally reconstructed 3D image is reduced occurs.

### SUMMARY

An aspect of the present disclosure is directed to providing an apparatus and method for plenoptic image processing, which may directly reconstruct a three-dimensional (3D) image from a raw image obtained by a plenoptic camera by using a pre-trained diffusion model (diffusion network), without a sub-aperture image generating process which causes a reduction in resolution of the reconstructed 3D image.

To achieve these and other advantages and in accordance with the purpose of the invention, as embodied and broadly described herein, there is provided a method for image processing, the method including: a step of collecting training data including a raw image, a two-dimensional (2D) image, and a depth image of the same object by using a data collection device; a step of learning the raw image and the 2D image to directly reconstruct a three-dimensional (3D) image from the raw image by using a diffusion network executed by a processor, based on a deep denoising learning method; and a step of updating a parameter of the diffusion network by using an update unit executed by the processor, based on a loss function representing a difference between the reconstructed 3D image and the depth image.

In another aspect of the present invention, there is provided a method for image processing, the method including: a step of modeling a simulation environment for plenoptic image processing based on user setting data and generating training data including a virtual raw image, a virtual two-dimensional (2D) image, and a virtual depth image corresponding to a virtual object in a modeled simulation environment by using a simulation unit executed by a processor; a step of learning the virtual raw image and the virtual 2D image to directly reconstruct a three-dimensional (3D) image from the virtual raw image by using a diffusion network executed by the processor, based on a deep denoising learning method; and a step of updating a parameter of the diffusion network by using an update unit executed by the processor, based on a loss function representing a difference between the reconstructed 3D image and the virtual depth image.

In another aspect of the present invention, there is provided an apparatus for image processing, the apparatus including: a data collection device configured to collect training data including a microlens obtained by a plenoptic camera, a two-dimensional (2D) image obtained by a 2D camera, and a depth image obtained by a depth sensor; and a processor configured to execute a diffusion network learning the microlens image and the 2D image to directly reconstruct a three-dimensional (3D) image from the microlens image, based on a deep denoising learning method.

According to embodiments of the present invention, plenoptic image processing for directly reconstructing a 3D image from a raw image obtained by using a pre-trained diffusion model (diffusion network) may be provided, and thus, a reduction in resolution caused by a process of converting the raw image into sub-aperture images may be prevented, thereby obtaining a high-resolution 3D image.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram of an apparatus for plenoptic image processing according to an embodiment of the present invention.

FIG. 2 is a block diagram of an apparatus for plenoptic image processing according to another embodiment of the present invention.

FIG. 3 is a flowchart of a method for plenoptic image processing according to an embodiment of the present invention.

FIG. 4 is a flowchart of a method for plenoptic image processing according to another embodiment of the present invention.

### DETAILED DESCRIPTION OF THE INVENTION

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

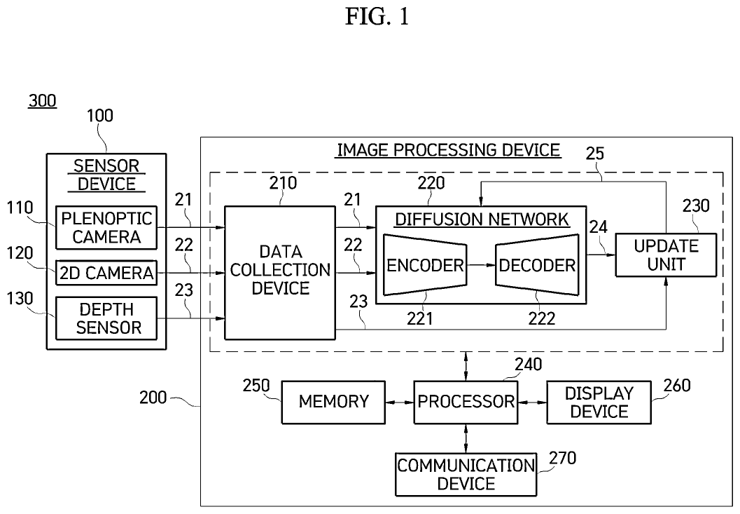

FIG. 1 is a block diagram of an apparatus 300 for plenoptic image processing according to an embodiment of the present invention.

Referring to FIG. 1, the apparatus 300 for plenoptic image processing according to an embodiment of the present invention may be configured to directly reconstruct a three-dimensional (3D) image from a raw image, without a process of converting the raw image into sub-aperture images. As described above, the apparatus 300 according to an embodiment of the present invention may reconstruct a high-resolution 3D image because a sub-aperture image generating process causing a reduction in resolution is omitted.

To this end, the apparatus 300 according to an embodiment of the present invention may be configured to include a pre-trained artificial neural network such as a below-described diffusion network 220, which directly reconstructs a three-dimensional (3D) image from a raw image. A gist of the present invention may be a training process of an artificial neural network.

In detail, the apparatus 300 may include a sensor device 100 and an image processing device 200. The sensor device 100 may generate training data for learning of the diffusion network 220. The sensor device 100 may be configured to include, for example, a plenoptic camera 110, a two-dimensional (2D) camera 120, and a depth sensor 130. The plenoptic camera 110 may be configured to include, for example, a main lens, a microlens array disposed behind the main lens, and a camera sensor. Based on such elements, the plenoptic camera 110 may photograph an object to generate a microlens image 21. Herein, the microlens image may be referred to as a raw image 21. The 2D camera 120 may photograph the object to generate a 2D image 22. Here, the 2D image may be defined as an image which does not include depth information. The 2D camera 120 may include, for example, a general camera such as a digital camera, a camera embedded in a smartphone, or a film camera. The depth sensor 130 may photograph the object to generate a depth image 23 having depth information. In this case, the depth information may include information representing a distance up to the object from the sensor device 100. The raw image 21, the 2D image 22, and the depth image 23 may be used as training data for learning of the diffusion network 220. Although described below, the depth image 23 may be used as ground truth data for calculating a loss function of the diffusion network 220.

The image processing device 200 may be a computing device which is connected to the sensor device 100 through wired or wireless communication and learns the training data received from the sensor device 100 to reconstruct a high-resolution 3D image 24 from the raw image 21. The computing device may be, for example, a smartphone, a tablet computer, a laptop computer, a desktop computer, or a server.

In detail, the image processing device 200 may include a data collection device 210, the diffusion network 220, and an update unit 230, and moreover, may further include a processor 240, a memory 250, a display device 260, and a communication device 270.

The data collection device 210 may be a storage device which collects the raw image 21, the 2D image 22, and the depth image 23, which are used as the training data obtained by the sensor device 100. The storage device may include, for example, a hard disk drive, a solid state drive (SSD), a memory, and a universal serial bus (USB) flash drive.

The diffusion network 220 may be an artificial neural network model which is executed and/or controlled by the processor 240 and may be referred to as a denoising autoencoder or a deep denoising generative model. The diffusion network 220 may learn the raw image 21 and the 2D image 22, which are used as the training data, and may directly reconstruct the high-resolution 3D image 24 from the raw image 21. To this end, the diffusion network 220, for example, may be configured in a neural network structure such as U-Net and may include an encoder 221 for compressing data and a decoder 222 which reconstructs (recovers) data compressed by the encoder 221. The diffusion network 220 may finally reconstruct the high-resolution 3D image 24 through a denoising process of removing step-by-step noise of an input image input to the diffusion network 220 by using the encoder 221 and the decoder 222.

The 2D image 22 in training data used in learning of the diffusion network 220 may be used as conditioning for increasing a learning speed of the diffusion network 220 and an accuracy of an output (the reconstructed 3D image) of the diffusion network 220. A difference between the 3D image 24 reconstructed by the diffusion network 220 and the raw image 21 which is the microlens image may be very large. Therefore, such a large difference may decrease a learning speed of the diffusion network 220 and an accuracy of the output (the reconstructed 3D image) of the diffusion network 220. To solve such a problem, the 2D image 22 may be used as conditioning which is set in a training process of the diffusion network 220. That is, the 2D image 22 may function as a regularization term which decreases a difference between the reconstructed 3D image 24 output from the diffusion network 220 and the raw image 21 input to the diffusion network 220 in a training process of the diffusion network 220, and thus, learning of the diffusion network 220 may be adjusted to flexibly reconstruct the 3D image 24 in a direction desired by a designer.

The update unit 230 may update a parameter 25 of the diffusion network 220. Here, the parameter 25 of the diffusion network 220 may include, for example, a weight and/or a bias of the diffusion network 220. To this end, for example, the update unit 230 may calculate a loss function representing a difference between the depth image 23 used as ground truth data input from the data collection device 210 and the 3D image 24 reconstructed by the diffusion network 220 in the training process and may calculate the parameter 25 of the diffusion network 220 in a direction in which the loss function decreases. Subsequently, the update unit 230 may update a previous parameter of the diffusion network 220 to the calculated parameter 25. Through such a process of updating the parameter 25 of the diffusion network 220, the diffusion network 220 may be optimized.

As another example, the loss function may be a difference between a Gaussian distribution of pixel values of the 3D image 24 reconstructed by the diffusion network 220 and a Gaussian distribution of pixel values of the depth image 23 which is the ground truth data. In more detail, the update unit 230 may fit the pixel values of the depth image 23 to a first Gaussian function and may fit the pixel values of the reconstructed 3D image 24 to a second Gaussian function. Here, a process of fitting the pixel values to a Gaussian function may denote a process of modeling the pixel values to a Gaussian distribution. Subsequently, the update unit 230 may calculate the loss function representing a difference between the first Gaussian function and the second Gaussian function. In this case, the difference between the first Gaussian function and the second Gaussian function may be a mean difference or a standard deviation difference between a first Gaussian distribution representing the first Gaussian function and a second Gaussian distribution representing the second Gaussian function.

A training method of the diffusion network 220 described above may use, for example, a stochastic gradient descent (SGD) or a deep denoising learning method. Such a learning method may include a forward process, a reverse process, a variational inference process, a conditional generation process, and a training schedule.

The forward process may include a noise addition process and a Markov chain process. The noise addition process may be a process of progressively adding noise to the raw image 21 to convert into random data. Such a process may generally include hundreds to thousands of steps. The Markov chain process may be a process of modeling a Markov chain where each step depends on an output of a previous step. The noise may be progressively added in each step, and accordingly, may completely reach a random distribution.

The reverse process may be a process corresponding to a reverse direction of the forward process and may be a process of progressively recovering (reconstructing) to raw data in a random noise state. Such a process may perform a function of the decoder 222 which removes noise and may finally generate data close to the raw data.

The variational inference may include an evidence lower bound (ELBO) optimization process and a regularization term addition process. A training target of the diffusion network may be for optimizing an ELBO and may be equal to optimizing a log-likelihood of data. In such a process, the encoder 221 may encode data as a latent space, and based thereon, the decoder 222 may reconstruct data. Also, a regularization term for avoiding undesired complexity in a training process may be added.

The conditional generation process may be a process of training the diffusion network 220 to generate data, based on a specific condition (for example, a class label and text description). To this end, conditional information may be provided to the encoder 221 and the decoder 222. Here, the conditional information may be the 2D image 22 obtained by the 2D camera 120.

The training schedule process may be a process of adjusting a distribution and a size of noise in a noise addition and removal process which is a significant factor in the training process of the diffusion network 220.

Moreover, the processor 240 may be a device which executes and/or controls an overall operation of the peripheral elements 210, 220, 230, 250, 260, and 270 in the image processing device 200 and may include at least one central processing unit (CPU) and/or at least one graphics processing unit (GPU). Also, the processor 240 may be implemented as an on device artificial intelligence (AI) chip or a neural processing unit (NPU), which is specialized for an artificial neural network (AI) operation such as a matrix multiplication and a convolutional operation.

The memory 250 may be a device which temporarily and/or permanently stores various program instructions necessary for an AI operation and training of the diffusion network 220 and may output the program instructions to the processor 240, based on a request of the processor 240.

The display device 260 may be a device which displays intermediate data and/or output data, generated in the training process of the diffusion network 220, in the form of visual information and may include, for example, a liquid crystal display (LCD) and an organic light emitting diode (OLED) display.

The communication device 270 may support wired or wireless communication with the sensor device 100. Here, wireless communication may include, for example, Bluetooth and Wi-Fi. Also, the communication device 270 may transmit an output of the diffusion network 220 to an external computing device through wired or wireless communication.

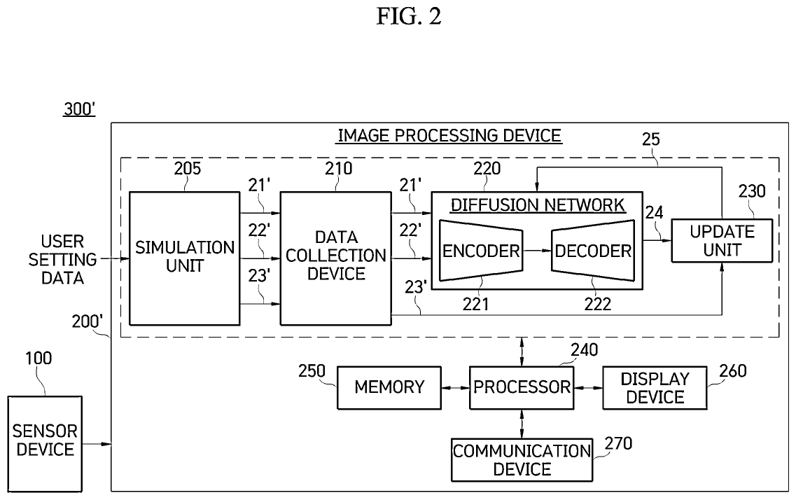

FIG. 2 is a block diagram of an apparatus 300′ for plenoptic image processing according to another embodiment of the present invention.

Referring to FIG. 2, the apparatus 300′ according to another embodiment of the present invention may use virtual image data, obtained through a simulation, as training data of the diffusion network 220, and thus, may have a difference with the embodiment of FIG. 1 where pieces of data 21 to 23 measured by the sensor device 100 are used as the training data of the diffusion network 220.

Except for that the apparatus 300′ according to another embodiment of the present invention may include a sensor device 100 and an image processing device 200′, and the image processing device 200′ further includes a simulation unit 205, the apparatus 300′ according to another embodiment of the present invention may be designed to be substantially equal to the apparatus 300 of FIG. 1. Therefore, for convenience of description, the simulation unit 205 will be mainly described below, and the descriptions of the other elements 210 to 270 may be replaced with the descriptions of FIG. 1 or will be briefly given.

The simulation unit 205 may model various simulation environments through a simulation based on user setting data input through an input interface (not shown) of the image processing device 200′ and may generate training data for training of the diffusion network 220 in a modeled simulation environment. As described above, in another embodiment of the present invention, because training data is constructed through a simulation, the cost and a time necessary for constructing the training data may be reduced compared to the embodiment of FIG. 1 where training data is constructed through real measurement of the sensor device 100.

The user setting data may include, for example, specification data of the virtual sensor device 100, size data of a virtual object, and distance data up to the virtual sensor device from the virtual object.

The specification data of the virtual sensor device 100 may include specification data of the plenoptic camera 110, specification data of the 2D camera 120, and specification data of the depth sensor 130. The specification data of the plenoptic camera 110 may include, for example, data associated with a resolution (for example, the number of horizontal and vertical pixels, etc.) of a microlens image capturable by the plenoptic camera 110, a field of view, an aperture size, a focal length, a frame rate representing the number of frames capable of being captured by a sensor per second, a size of a microlens, an array pattern of a microlens, and the number of microlenses. The specification data of the 2D camera 120 may include, for example, a resolution, a physical size of an image sensor, a focal length, an aperture size, a shutter speed, ISO sensitivity, and a frame rate. The specification data of the depth sensor 130 may include, for example, a resolution, a measurement range representing a minimum distance and a maximum distance capable of being measured by a sensor, accuracy which is an indicator representing an accuracy of a depth value measured by the sensor, a frame rate, and a field of view.

The training data generated by the simulation unit 205 may include a virtual microlens image 21′ (hereinafter referred to as a ‘virtual raw image’), a virtual 2D image 22′, and a virtual depth image 23′, which are respectively obtained by photographing a virtual object set by a user by using a virtual plenoptic camera, a virtual 2D camera, and a virtual depth sensor in a simulation environment modeled based on the user setting data. Here, the virtual depth image 23′ may be used as ground truth data.

The simulation unit 205 generating the training data may be implemented with, for example, 3D modeling software or separate hardware where the 3D modeling software is installed. Here, the 3D modeling software may include, for example, Blender and/or 3D Max.

The diffusion network 220 according to another embodiment of the present invention may learn pieces of training data 21′, 22′, and 23′ generated by the simulation unit 205 to directly reconstruct a high-resolution 3D image from a real raw image.

The update unit 230 according to another embodiment of the present invention may calculate a loss function representing a difference between the virtual depth image 23′ used as the ground truth data and the 3D image 24 reconstructed by the diffusion network 220 in a training process of the diffusion network and may calculate the parameter 25 (for example, a weight and/or a bias) of the diffusion network 220 in a direction in which the loss function decreases. A previous parameter of the diffusion network 220 may be updated to the calculated parameter 25 by the update unit 230.

As another example, the loss function may be a difference between a Gaussian distribution of pixel values of the 3D image 24 reconstructed by the diffusion network 220 and a Gaussian distribution of pixel values of the virtual depth image 23′ which is the ground truth data. In more detail, the update unit 230 may fit the pixel values of the virtual depth image 23′ to the first Gaussian function and may fit the pixel values of the reconstructed 3D image 24 to the second Gaussian function. Subsequently, the update unit 230 may calculate the loss function representing a difference between the first Gaussian function and the second Gaussian function. Here, the difference between the first Gaussian function and the second Gaussian function may be a mean difference or a standard deviation difference between the first Gaussian distribution representing the first Gaussian function and the second Gaussian distribution representing the second Gaussian function.

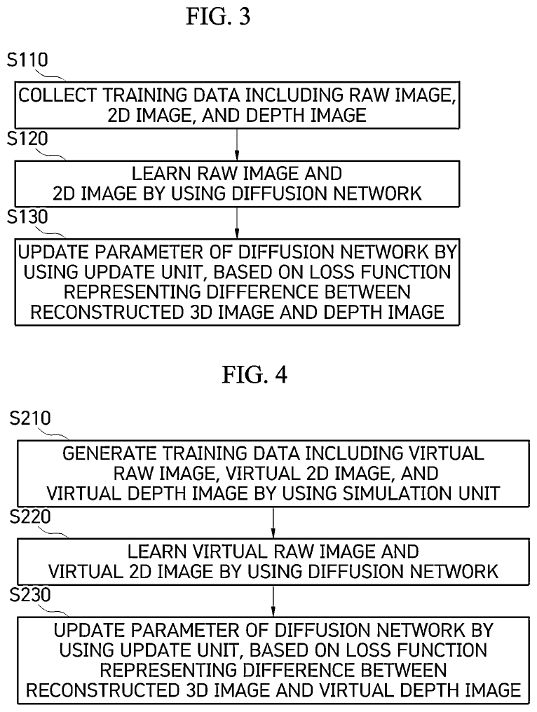

FIG. 3 is a flowchart of a method for plenoptic image processing according to an embodiment of the present invention.

Referring to FIG. 3, first, in step S110, the data collection device 210 may collect training data including the raw image 21, the 2D image 22, and the depth image 23.

Subsequently, in step S120, the diffusion network 220 may learn the raw image 21 and the 2D image 22 to directly reconstruct the 3D image 24 from the raw image 21 without a process of converting the raw image 21 into sub-aperture images, based on a deep denoising learning method.

Subsequently, in step S130, the update unit 230 executed by the processor 240 may update a parameter of the diffusion network 220, based on a loss function representing a difference between the reconstructed 3D image 24 and the depth image 23.

In an embodiment, the step S110 may include a process of collecting the raw image 21 obtained by photographing an object by using the plenoptic camera 110, a process of collecting the 2D image 22 obtained by photographing the object by using the 2D camera 120, and a process of collecting a depth image obtained by photographing the object by using the depth sensor 130.

In an embodiment, the raw image 21 may be a microlens image.

In an embodiment, the 2D image may be used as conditional information which is used in the deep denoising learning method.

In an embodiment, the depth image 22 may be used as ground truth data for calculating the loss function.

In an embodiment, the step S130 may include a process of calculating a loss function representing a difference between the reconstructed 3D image 24 and the depth image 23 used as ground truth data, a process of calculating a new parameter of the diffusion network 220 in a direction in which the calculated loss function decreases, and a process of updating a parameter of the diffusion network to the new parameter.

In another embodiment, the step S130 may include a process of fitting pixel values of the depth image 23 to the first Gaussian function and fitting pixel values of the reconstructed 3D image 24 to the second Gaussian function, a process of calculating a loss function representing a difference between the first Gaussian function and the second Gaussian function, a process of calculating a new parameter in a direction in which the calculated loss function decreases, and a process of updating the parameter of the diffusion network 220 to the new parameter.

FIG. 4 is a flowchart of a method for plenoptic image processing according to another embodiment of the present invention.

Referring to FIG. 4, first, in step S210, the simulation unit 205 executed by the processor 240 may model a simulation environment for plenoptic image processing based on user setting data and may generate training data including a virtual raw image 21′, a virtual 2D image 22′, and a virtual depth image 23′ corresponding to a virtual object in a modeled simulation environment. Here, the simulation unit 205 may include, for example, the 3D modeling software such as Blender and/or 3D Max.

Subsequently, in step S220, the diffusion network 220 executed by the processor 240 may learn the virtual raw image 21′ and the virtual 2D image 22′ to directly reconstruct the 3D image 24 from the virtual raw image 21′ without a process of converting the virtual raw image 21′ into sub-aperture images, based on a deep denoising learning method.

Subsequently, in step S230, the update unit 230 executed by the processor 240 may update a parameter of the diffusion network 220, based on a loss function representing a difference between the reconstructed 3D image 24 and the virtual depth image 23′.

In an embodiment, the step S210 may include a process of generating the virtual raw image obtained by photographing a virtual object with a virtual plenoptic camera simulated based on the user setting data, a process of generating the 2D image obtained by photographing the virtual object with a virtual 2D camera simulated based on the user setting data, and a process of generating the depth image obtained by photographing the virtual object with a virtual depth sensor simulated based on the user setting data.

In an embodiment, the virtual raw image 21′ may be a microlens image.

In an embodiment, the virtual 2D image 22′ may be used as conditional information which is used in the deep denoising learning method.

In an embodiment, the virtual depth image 23′ may be used as ground truth data for calculating the loss function.

In an embodiment, the step S230 may include a process of calculating a loss function representing a difference between the reconstructed 3D image 24 and the virtual depth image 23′ used as the ground truth data, a process of calculating a new parameter in a direction in which the calculated loss function decreases, and a process of updating a parameter of the diffusion network 220 to the new parameter.

In an embodiment, the step S230 may include a process of fitting pixel values of the virtual depth image 23′, used as the ground truth data, to the first Gaussian function and fitting pixel values of the reconstructed 3D image 24 to the second Gaussian function, a process of calculating a loss function representing a difference between the first Gaussian function and the second Gaussian function, a process of calculating a new parameter in a direction in which the calculated loss function decreases, and a process of updating the parameter of the diffusion network 220 to the new parameter.

In an embodiment, the user setting data may include specification data of a virtual sensor device including a virtual plenoptic camera, a virtual 2D camera, and a virtual depth sensor, size data of the virtual object, and distance data between the virtual sensor device and the virtual object.

As described above, in the plenoptic image processing method according to embodiments of the present invention, a high-resolution 3D image may be directly reconstructed from a raw image by a pre-trained diffusion model, without a process of converting the raw image into sub-aperture images. Therefore, in the plenoptic image processing method according to embodiments of the present invention, because there is no process of generating the sub-aperture images, a resolution of the reconstructed 3D image may not be reduced by the sub-aperture images, and the present invention may be applied to a small-size camera where a sensor size is small. Also, the number of operations based on the process of generating the sub-aperture images may decrease.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for image processing, the method comprising:
a step of collecting training data including a raw image, a two-dimensional (2D) image, and a depth image of the same object by using a data collection device;
a step of learning the raw image and the 2D image to directly reconstruct a three-dimensional (3D) image from the raw image by using a diffusion network executed by a processor, based on a deep denoising learning method; and
a step of updating a parameter of the diffusion network by using an update unit executed by the processor, based on a loss function representing a difference between the reconstructed 3D image and the depth image.

2. The method of claim 1, wherein the step of collecting the training data comprises:
a step of collecting the raw image obtained by photographing an object by using a plenoptic camera;
a step of collecting the 2D image obtained by photographing the object by using a 2D camera; and
a step of collecting a depth image obtained by photographing the object by using a depth sensor.

3. The method of claim 1, wherein the raw image is a microlens image.

4. The method of claim 1, wherein the 2D image is used as conditional information used in the deep denoising learning method.

5. The method of claim 1, wherein the depth image is used as ground truth data for calculating the loss function.

6. The method of claim 1, wherein the step of updating the parameter of the diffusion network comprises:
a step of calculating a loss function representing a difference between the reconstructed 3D image and the depth image used as ground truth data;
a step of calculating a new parameter of the diffusion network in a direction in which the calculated loss function decreases; and
a step of updating a parameter of the diffusion network to the new parameter.

7. The method of claim 1, wherein the step of updating the parameter of the diffusion network comprises:
a step of fitting pixel values of the depth image, used as ground truth data, to a first Gaussian function and fitting pixel values of the reconstructed 3D image to a second Gaussian function;
a step of calculating a loss function representing a difference between the first Gaussian function and the second Gaussian function;
a step of calculating a new parameter in a direction in which the calculated loss function decreases; and
a step of updating the parameter of the diffusion network to the new parameter.

8. A method for image processing, the method comprising:
a step of modeling a simulation environment for plenoptic image processing based on user setting data and generating training data including a virtual raw image, a virtual two-dimensional (2D) image, and a virtual depth image corresponding to a virtual object in a modeled simulation environment by using a simulation unit executed by a processor;
a step of learning the virtual raw image and the virtual 2D image to directly reconstruct a three-dimensional (3D) image from the virtual raw image by using a diffusion network executed by the processor, based on a deep denoising learning method; and
a step of updating a parameter of the diffusion network by using an update unit executed by the processor, based on a loss function representing a difference between the reconstructed 3D image and the virtual depth image.

9. The method of claim 8, wherein the step of generating the training data comprises:
a step of generating the virtual raw image obtained by photographing a virtual object by using a virtual plenoptic camera simulated based on the user setting data;
a step of generating the 2D image obtained by photographing the virtual object by using a virtual 2D camera simulated based on the user setting data; and
a step of generating a depth image obtained by photographing the virtual object by using a virtual depth sensor simulated based on the user setting data.

10. The method of claim 8, wherein the virtual raw image is a microlens image.

11. The method of claim 8, wherein the virtual 2D image is used as conditional information used in the deep denoising learning method.

12. The method of claim 8, wherein the virtual depth image is used as ground truth data for calculating the loss function.

13. The method of claim 8, wherein the step of updating the parameter of the diffusion network comprises:
a step of calculating a loss function representing a difference between the reconstructed 3D image and the virtual depth image used as ground truth data;
a step of calculating a new parameter in a direction in which the calculated loss function decreases; and
a step of updating a parameter of the diffusion network to the new parameter.

14. The method of claim 8, wherein the step of updating the parameter of the diffusion network comprises:
a step of fitting pixel values of the virtual depth image, used as ground truth data, to a first Gaussian function and fitting pixel values of the reconstructed 3D image to a second Gaussian function;
a step of calculating a loss function representing a difference between the first Gaussian function and the second Gaussian function;
a step of calculating a new parameter in a direction in which the calculated loss function decreases; and
a step of updating the parameter of the diffusion network to the new parameter.

15. The method of claim 8, wherein the user setting data comprises specification data of a virtual sensor device including a virtual plenoptic camera, a virtual 2D camera, and a virtual depth sensor, size data of the virtual object, and distance data between the virtual sensor device and the virtual object.

16. An apparatus for image processing, the apparatus comprising:
a data collection device configured to collect training data including a microlens obtained by a plenoptic camera, a two-dimensional (2D) image obtained by a 2D camera, and a depth image obtained by a depth sensor; and
a processor configured to execute a diffusion network learning the microlens image and the 2D image to directly reconstruct a three-dimensional (3D) image from the microlens image, based on a deep denoising learning method.

17. The apparatus of claim 16, wherein the processor executes an update unit configured to update a parameter of the diffusion network, based on a loss function representing a difference between the reconstructed 3D image and the depth image.

18. The apparatus of claim 17, wherein the depth image is used as ground truth data for calculating the loss function.

19. The apparatus of claim 17, wherein the loss function represents a difference between a Gaussian distribution of pixel values of the reconstructed 3D image and a Gaussian distribution of pixel values of the depth image.

20. The apparatus of claim 16, wherein the 2D image is used as conditional information used in the deep denoising learning method.
